(19) United States
(12) Patent Application Publication
(10) Pub. No.: US 2014/0101368 A1
(43) Pub. Date: Apr. 10, 2014

(54) Binding microprocessor to memory chips to prevent re-use of microprocessor

(71) Applicant: QUALCOMM INCORPORATED, San Diego, CA (US)

(72) Inventors: Gregory Gordon ROSE, San Diego, CA (US); Anand PALANIGOUNDER, San Diego, CA (US); Alexander GANTMAN, Poway, CA (US); Jiang ZHANG, San Diego, CA (US)

(73) Assignee: QUALCOMM Incorporated, San Diego, CA (US)

(21) Appl. No.: 13/644,816

(22) Filed: Oct. 4, 2012

(51) Int. Cl. G06F 12/02

(52) U.S. Cl. 711/103; 711/E12.008

(57) ABSTRACT

A processor is provided that binds itself to a circuit such that the processor cannot be subsequently reused in other circuits. On a first startup of the processor, a memory segment of an external volatile memory device is read to obtain information prior to initialization of the memory segment. An original/initial identifier may be generated from the information read from the memory segment. The original/initial identifier may then be stored in a non-volatile storage of the processor. On subsequent startups of the processor, it verifies that the processor is still coupled to the same external volatile memory device by using the stored identifier. For instance, on a subsequent startup, the processor again reads the same memory segment of the external memory device and generates a new identifier. If the identifier matches the previously stored identifier, then the processor may continue its operations; otherwise the processor is disabled/halted.

### BACKGROUND

1. Field

One feature relates to the preventing the reuse of microprocessors and more particularly to a binding a microprocessor to an initial hardware circuit in such a way that it cannot be reused.

2. Background

Microprocessors are ubiquitous in electronic devices, such as computers, mobile devices, mobile phones, personal digital assistants, digital tablets, among other communication and/or processing devices. In some instances, these microprocessors may be recycled and/or reused by removal from an original first circuit and reused in a second circuit. However, recycled microprocessors may be mislabeled and/or reused in such a way as to mislead consumers about the capabilities of a product into which a microprocessor is reinstalled. For example, a microprocessor may be overclocked and/or mislabeled to appear as a faster microprocessor and/or a microprocessor that operates over a faster network. Such may be the case, for instance, with wireless modem microprocessors that are designed to operate over a 3G network but may be reused on mobile phones advertised as 4G network compatible, thus misleading consumers.

Therefore, a way is needed to prevent such misuse and/or reuse of microprocessors.

### SUMMARY

Various techniques described herein bind the operation of a processor to the first circuit on which it is booted up.

First example provides a method of binding a processor to a particular external volatile memory device. On a first startup of the processor, a memory segment of the external volatile memory device is read to obtain information prior to initialization of the memory segment. The memory segment may comprise a plurality of n bytes obtained from memory cells of the external memory device prior to initializing the memory cells to any value.

An identifier is generated from the information read from the memory segment. The identifier is then stored in a non-volatile storage of the processor. For instance, the non-volatile storage of the processor may include a one-time writable storage. On subsequent startups, the processor verifies that it is still coupled to the same external volatile memory device by using the stored identifier. Generating the identifier from the information read from the memory segment may include: (a) reading states of a plurality of memory cells within the memory segment, and/or (b) converting the plurality of states to the identifier. The states may include one of a logical 0 and a logical 1. In one example, converting the plurality of states to the identifier may include at least one of: (a) concatenating the states of the plurality of memory cells as a binary sequence, and/or (b) performing a logic operation that combines at least some of the plurality of states of the plurality of memory cells into the identifier.

According to one aspect, verifying that the processor is still coupled to the same external volatile memory device may include: (a) retrieving the previously stored identifier from the non-volatile storage of the processor; and/or (b) disabling operation of the processor if a subsequently obtained identifier for the same memory segment does not match the previously stored identifier.

In other instances, on a restart of the processor, the memory segment of the external volatile memory device may be read prior to initialization of the memory segment. A second identifier may be generated from information read from the memory segment. The previously stored identifier is then retrieved from the non-volatile storage of the processor. Operation of the processor may be disabled if the generated second identifier does not match the previously stored identifier.

According to another aspect, an error correction code for the information read from the memory segment may be generated and stored. The error correction code may be applied to a subsequently obtained second identifier during a restart of the processor prior to a comparison with the previously stored identifier.

According to yet another aspect, one or more other memory segments of different external volatile memory devices may be read to obtain additional information prior to initialization of the one or more other memory segments. The identifier may then be generated from the additional information read from the one or more other memory segments.

According to an additional aspect, one or more other memory segments of different external volatile memory devices may read to obtain additional information prior to initialization of the one or more other memory segments. A plurality of identifiers may then be generated from the additional information read from the one or more other memory segments. The plurality of identifiers may also be stored in the non-volatile storage of the processor.

According to yet another aspect, the identifier may be generated from a first portion of the information read. One or more additional identifiers may be generated from other portions of the information read. The one or more additional identifiers may also be stored in the non-volatile storage of the processor.

A second example provides a processor comprising a non-volatile storage and a processing circuit coupled to the non-volatile storage. The processing circuit may be configured to: (a) read a memory segment of an external volatile memory device to obtain information prior to initialization of the memory segment on a first startup of the processor, (b) generate an identifier from the information read from the memory segment, and/or (c) store the identifier in the non-volatile storage. On subsequent startups, the processing circuit may verify that the processor is still coupled to the same external volatile memory device by using the stored identifier. In one example, verifying that the processor is still coupled to the same external volatile memory device may include: (a) retrieving the previously stored identifier from the non-volatile storage of the processor; and/or (b) disabling operation of the processor if a subsequently obtained identifier for the same memory segment does not match the previously stored identifier.

According to yet another example, the processing circuit may be further adapted to: (a) read the memory segment of the external volatile memory device to obtain information prior to initialization of the memory segment on a restart of the processor; (b) generate a second identifier from the information read from the memory segment; (c) retrieve the previously stored identifier from the non-volatile storage of the processor; and/or (d) disable operation of the processor if the generated second identifier does not match the previously stored identifier.

A third example provides a method for binding a processor to a particular external volatile memory device. On a restart of the processor, a segment of an external volatile memory device is read to obtain information prior to initialization of the memory segment. An identifier is generated from the information read from the memory segment. A previously stored identifier is retrieved from a non-volatile storage of the processor. Operation of the processor may be disabled if the generated identifier does not match the previously stored identifier.

According to one aspect, an error correction code may be retrieved from the non-volatile storage of the processor. The error correction code may be applied to the information read from the memory segment to obtain a corrected identifier. Operation of the processor may be disabled if the corrected identifier does not match the previously stored identifier.

A fourth example provides a processor comprising: a non-volatile storage and a processing circuit coupled to the non-volatile storage. The processing circuit may be configured to: (a) read a segment of an external volatile memory device to obtain information prior to initialization of the memory segment on a restart of the processor, (b) generate an identifier from the information read from the memory segment, (c) retrieve a previously stored identifier from the non-volatile storage of the processor, and/or (d) disable operation of the processor if the generated identifier does not match the previously stored identifier.

### BRIEF DESCRIPTION OF THE DRAWINGS

The features, nature, and advantages of the present aspects may become more apparent from the detailed description set forth below when taken in conjunction with the drawings in which like reference characters identify correspondingly throughout.

FIG. 1 illustrates the concept of binding a processor to a circuit to inhibit reuse of the processor on other circuits.

FIG. 2 illustrates a processor that is configured to bind itself to an external volatile memory device on the same circuit board.

FIG. 3 illustrates the use of uninitialized memory cells/junctions to generate an identifier used to authenticate/verify that a processor is still coupled to the same external volatile memory device during subsequent boot-ups or power cycling.

FIG. 4 illustrates a method operational by a processor to bind the processor to a volatile memory device by using an identifier obtained from the uninitialized volatile memory device.

FIG. 5 is a flow diagram illustrating an example of how to verify a previous binding between a processor to a particular volatile memory device.

FIG. 6 illustrates a method for binding a processor to a particular external volatile memory device.

FIG. 7 is a block diagram illustrating an exemplary mobile communication device that includes a processor that is bound to one or more volatile memory devices.

### DETAILED DESCRIPTION

In the following description, specific details are given to provide a thorough understanding of the embodiments. However, it will be understood by one of ordinary skill in the art that the embodiments may be practiced without these specific details. For example, circuits may be shown in block diagrams, or not be shown at all, in order not to obscure the embodiments in unnecessary detail. In other instances, well-known circuits, structures and techniques may not be shown in detail in order not to obscure the embodiments.

### Overview

Several novel features pertain to binding a processor to other hardware components of a circuit, thereby preventing reuse of the processor in other circuits. In one example, the processor may ascertain identifying information from a memory segment and securely store such information for subsequent boot-ups. For instance, the memory segment may comprise a plurality of uninitialized memory cells (also referred to as memory junctions). The state of some of these uninitialized cells may be consistently or predictably biased (e.g., 0 or 1) to the same state on every power up or boot-up cycle. This consistent biasing of some uninitialized memory cells may be checked by the processor on subsequent boot-ups to ascertain whether it matches its previously stored identifying information. If so, the processor proceeds with further operations. Otherwise, it may be assumed that the processor has been moved to a new circuit and may be disabled from performing further operations.

### Exemplary Hardware Environment

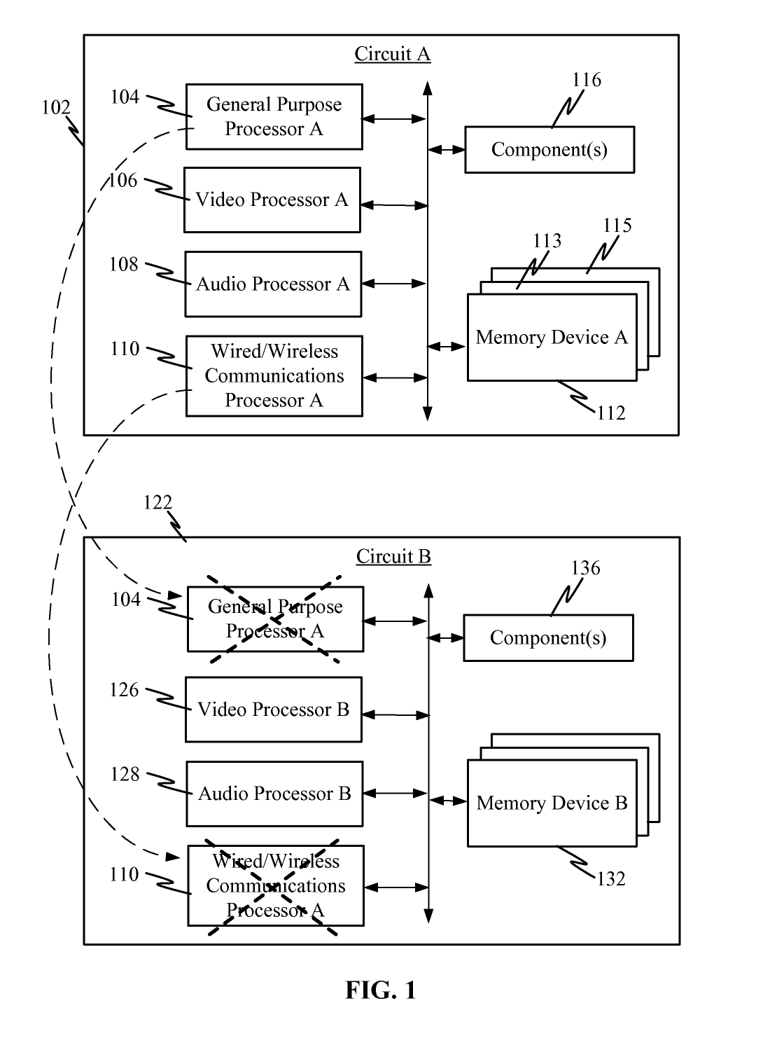

FIG. 1 illustrates the concept of binding a processor to a circuit to inhibit reuse of the processor on other circuits. A first circuit A 102 may include one or more processors, such as a general purpose processor A 104, a video processor A 106, an audio processor A 108, and/or a wired/wireless communications processor A 110. The one or more processors may be communicatively coupled (e.g., over a bus) to one or more memory devices 112, 113, and/or 115 (e.g., random access memory, volatile memory, etc.). Each memory device 112, 113, and/or 115 may represent a single memory semiconductor device or a plurality of memory semiconductor devices (e.g., a memory stack). For example, each memory device 112, 113, and/or 115 may be one or more memory chips. Upon testing or an initial power-up (e.g., either during manufacturing or upon first use), at least one of the one or more processors 104, 106, 108, and/or 110 may obtain identifying information from one or more other components 112 and/or 116 with which it communicates and stores this information internally (e.g., within the processor) for future authentication/verification during power-up. Such one or more other components 112 and/or 116 may include memory devices, processors, sensors, etc., on the circuit 102 with which a processor is capable of communicating.

For instance, the identifying information may be obtained from the memory device A 112, e.g., one or more of the memory chips or segments therefrom. Such identifying information may be read from the memory device A 112 before it is initialized, e.g., before the memory cells in the memory device are set to a default state/value. For example, each processor that implements this authentication/verification feature may be adapted to read n bytes (e.g., 100 bytes or bits, 1000 bytes or bits, 10 kilobytes or kbits, 1 megabytes or megabits, etc.) starting at a certain memory address. The read values of such n bytes/bits may be stored as the identifying information by the processor in an internal non-volatile storage. Such non-volatile storage may be, for example, in one-time writable storage or burnable fuses within the processor. Note that the identifying information may be obtained not just from a single memory device/chip but also from a plurality of different memory devices/chips and also from the other components 116 on the circuit A 102.

In subsequent boot-ups or power on cycles, the one or more processors implementing the authentication/verification feature may again read the identifying information from the same components and compares it to the previously stored identifying information. Note that due to the nature of uninitialized memory cells or junctions, it is unlikely that the uninitialized memory cell states for the memory device A 112 will be the same on every boot-up. Consequently, in some implementations, error correcting codes may be applied to the identifying information read on subsequent boot-ups. So long as there is some bias in the set of memory cells read (i.e., some of the memory cells have the same state as when they were initially read), then the error correcting code will correct differences in the subsequently read memory cells. If there is a match or a match greater than a threshold minimum, then the processor operations may continue. Otherwise, the processor may stop further operations (e.g., cease to execute instructions, execute an endless loop, etc.).

If one or more of the processor 104, 106, 108, and/or 110 is subsequently moved to a different circuit, they will fail to operate if the identifying information obtained from the different circuit does not match the information initially obtained from the first circuit A 102. For example, the general purpose processor A 104 and/or wired/wireless communications processor A 110 may have been moved to a second circuit B 122 that includes a video processor B 126, an audio processor B 128, and a memory device B 132 (that includes one or more semiconductor memory chips). Upon power-up or boot-up, the general purpose processor A 104 and/or wired/wireless communications processor A 110 may read the identifying information from the memory device B 132. Because this memory device B 132 is a different device from the memory device A 112, then the identifying information read from the memory device B 132 will not match the previously stored identifying information in the general purpose processor A 104 and/or wired/wireless communications processor A 110. For instance, the probability that the uninitialized memory states for a sufficiently large plurality of memory cells (e.g., 1 kilobytes) in both memory devices A 112 and B 132 being the same is extremely small. Consequently, these processors will stop further operations upon failure of such verification/authentication.

### Exemplary Processor Binding Using Uninitialized Memory

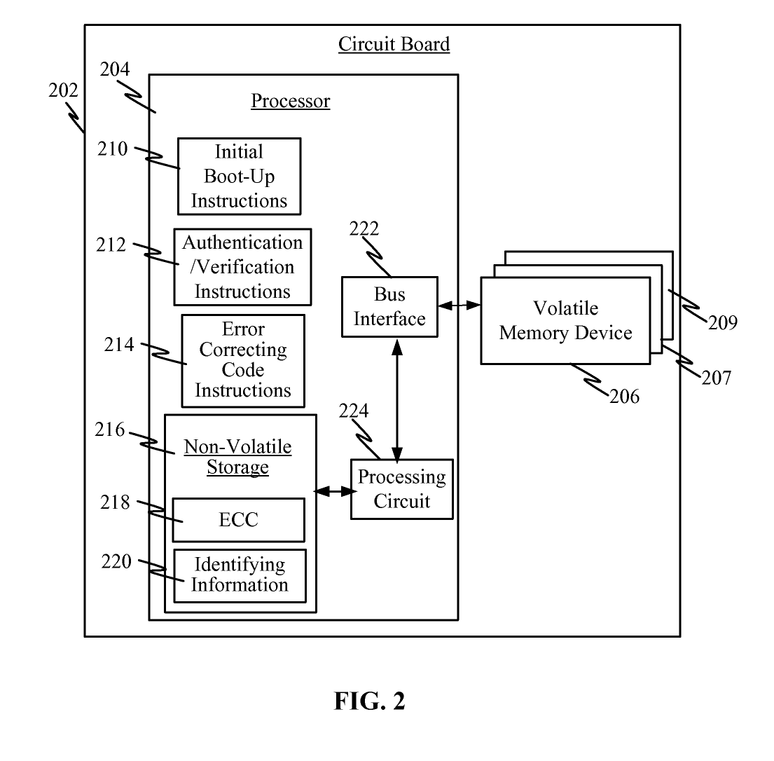

FIG. 2 illustrates a processor 204 that is configured to bind itself to an external volatile memory device 206 on the same circuit board 202. One way to prevent misuse of processors is to inhibit their reuse altogether. Here, the processor 204 may include a processing circuit 224, a bus interface 222, and/or a non-volatile storage 216 (e.g., a one-time writable storage device). The processing circuit 224 may serve to execute functions or operations, including initial boot-up instructions 210, authentication/verification instructions 212, and/or error correcting code instructions 214. The bus interface 222 may serve to couple the processor 204 (and/or processing circuit 224) to one or more external volatile memory devices 206, 207, and/or 209.

According to one aspect, a processor may be tied to the associated components (e.g., peripheral semiconductors) with which it communicates the first time the processor is used on a circuit board. For example, the first time the processor 204 is installed on the circuit board 202 and powered on, the initial boot-up instructions 210 may cause identifying information to be obtained for the volatile memory device 206 with which it communicates and stores that identifying information 220 in the non-volatile storage 216 (e.g., one-time writable storage such as internal burnable fuses) within the processor 204. In one implementation, the identifying information 220 may be obtained from a segment of memory (e.g., the first 1 kilobytes of a memory chip, or n kbytes/kbits from one or more different memory devices 206, 207, 209, etc.) prior to initialization. That is, while most memory cells or junctions may have an indeterminate/unknown state prior to initialization, some memory cells/junctions will be reliably biased to a particular state (e.g., 1 or 0 logical state, or high or low state) due to the electrical characteristics of the particular memory chip or junction. Consequently, these memory cells/junctions may be relied on to provide the same logic state (e.g., 1 or 0 bit) prior to initialization and may serve to uniquely identify a particular memory chip from a plurality of such reliable uninitialized memory cells/junctions. This unique identifier for a memory chip 208 may be stored as the “identifying information” 220 in the processor 204.

According to one example, on a first startup of the processor 204, a segment of the external volatile memory device 206 is read prior to initialization of the memory segment (e.g., from one or more chips 208). For instance, a plurality of bits may be ascertained (e.g., read) from a corresponding plurality of memory cells/junctions of the external volatile memory device 206. The uninitialized memory cells/junctions may be detected, for example, as logic state 1 or logic state 0 (e.g., “0001000101100001 . . . ”). An identifier may be generated from the information read from the memory segment. For example, the identifier may simply be the read memory states (e.g., “0001000101100001 . . . ”). Alternatively, the identifier may simply be the reliably read logic states 1 while setting all other bits to logic state 0 (e.g., “0001000101100001 . . . ”). The identifier may be stored in the non-volatile storage 216 portion of the processor 204. Such non-volatile storage 216 may include, for example, one-time writable storage and/or burnable fuses, or other mechanism that prevents the identifying information 220 (e.g., identifier) from being deleted, altered, or replaced with a different identifier.

On subsequent startups, the authentication/verification instructions 212 may cause the processor 204 to verify that it is still coupled to the same external volatile memory device 206 by using the stored identifying information 220 (e.g., identifier). This may include reading the same segment of the memory device 206 to obtain new identifying information (e.g., a new identifier) which is then compared to the initially obtained identifying information 220 (e.g., original identifier) to determine if there is a match or a match above a minimum threshold (e.g., 50% match or better, 75% match or better, etc.).

Additionally, the error correcting code instructions 214 may implement error correction techniques, an error correction code 218 may be computed over the uninitialized memory segment used to generate the identifying information 220 (e.g., identifier). That is, because uninitialized memory is used to generate the identifying information 220 (e.g., identifier), there is a chance that the state of some memory junctions therein may be different every time the processor 204 is started. The error correction code permits reconstructing an original identifier even when some memory junctions may have unreliable uninitialized states. So long as at least a subset of the memory cells/junctions (in a memory device or chip) are reliably biased to the same state on every startup of the processor, the error correction code serves to recreate the original identifier.

Optionally, the processor 204 may also generate and store an error correction code (ECC) 218 for the identifying information read from the memory segment. This error correction code may be applied to identifying information read on subsequent startups to correct any unreliable memory cells/junctions that may have switched states from the first time it was read.

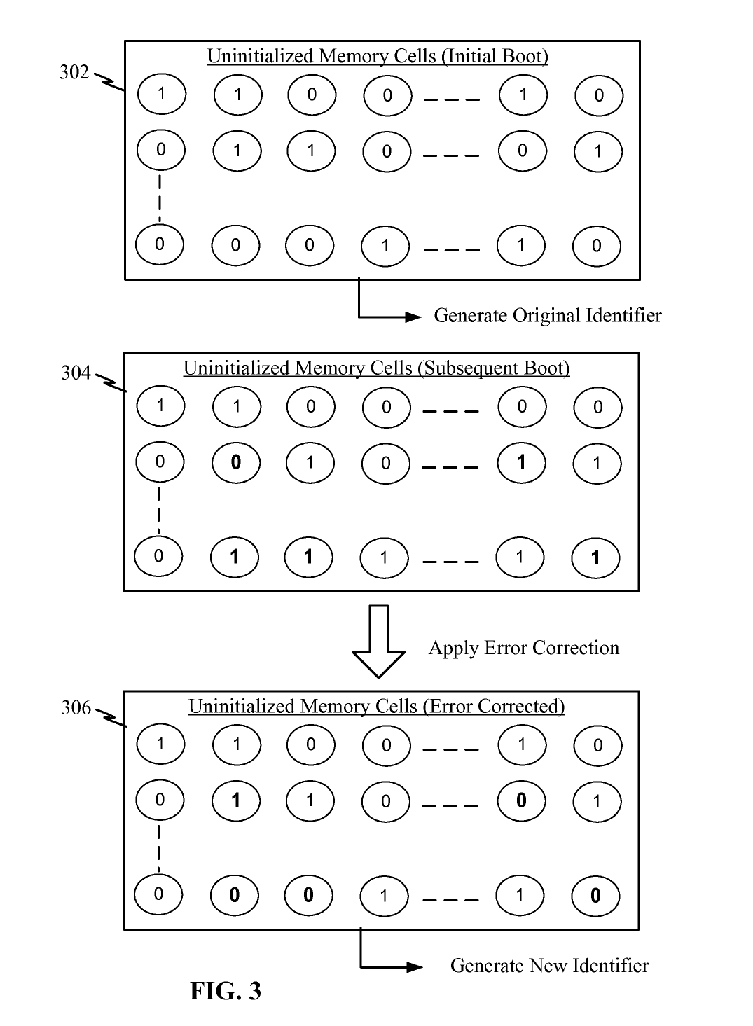

FIG. 3 illustrates the use of uninitialized memory cells/junctions to generate an identifier used to authenticate/verify that a processor is still coupled to the same external volatile memory device during subsequent boot-ups or power cycling. During an initial boot up, a plurality of uninitialized memory cells/junctions 302 are read and used to generate an original identifier. In subsequent boot ups of the processor, the uninitialized memory cells/junctions 304 are read, error correction may be optionally applied to obtain error corrected uninitialized memory cells/junctions 306, and a new identifier is generated. The original and new identifiers are compared to determine whether a match or a match above a threshold can be found. If not, then the processor may be disabled (e.g., stops operating or prevents further execution of applications).

The uninitialized memory cells/junctions used to generate an identifier are prone or susceptible to variations each time such uninitialized cells/junctions are read. That is, with the exception of some reliably biased memory cells/junctions, the state of other memory cells/junctions may be unpredictable on each start up. Consequently, the error correction code over a first instance of a memory segment (e.g., plurality of uninitialized memory cells at time t0) may be defined to allow correction of a subsequently read second instance of the same memory segment (e.g., plurality of uninitialized memory cells at time t1). Such error correction code may be based on various techniques/schemes, including probabilistic approaches.

In one example, the state of a first instance of a memory segment (e.g., plurality of uninitialized memory cells at time t0) may be read and the states may simply be stored in the non-volatile memory within the processor. In this example, the combination of logic states in the first instance of the memory segment may be used as the identifier. On subsequent boot-up of the processor, the same memory segment is read to obtain a second instance of the memory segment. The stored first instance is then retrieved and compared to the second instance to ascertain a match. Such “match” may be a probabilistic match such that, as long as a bit-to-bit match above a threshold (e.g., above 50%) is found, a match between the two instances is confirmed. For instance, such “match” may be may be confirmed so long as the correlation between bits in the first instance of the memory segment and second instance of the memory segment is more than merely random.

In another example, rather than storing the actual bits of the first instance of the memory segment, information derived from the first instance may be stored instead. For example, both the identifier and a corresponding error correction code for the first instance of the memory segment may be stored. For instance, fuzzy extractors may be used for error correction of noisy information (e.g., information that may change slightly each time it is read, like uninitialized memory cells/junctions). Fuzzy extractors are defined and discussed in detail in Fuzzy Extractors: How to Generate Strong Keys from Biometrics and Other Noisy Data, Yevgeniy Dodis, Rafail Ostrovsky, Leonid Reyzin, and Adam Smith, Society for Industrial and Applied Mathematics (SIAM) Journal on Computing, Vol. 38, Issue 1, pages 97-139, March 2008. A fuzzy extractor may be based on two basic primitives, firstly information reconciliation or error correction and secondly privacy amplification or randomness extraction, which guarantees an output which is very close to being a uniformly distributed random variable. In order to implement those two primitives, helper data W is generated during an initial phase (e.g., W may be generated using bits collected at the same time as bits collected for the original identifier from uninitialized memory cells/junctions). From the helper data W, a uniform and random string R may be extracted that has tolerance for noise. If on a subsequent boot-up the helper data W (e.g., uninitialized memory cells/junctions) changes to W′ but is still close to the original helper data W, the random string R can still be reconstructed. When the random string R is used a first time to reconstruct the original helper data W, it outputs a helper string P which can be stored to recover the random string R. During the authentication or verification phase, a new identifier is reconstructed based on a noisy measurement R′ (e.g., a reading of the same memory cells used to generate the original identifier) and the helper data W.

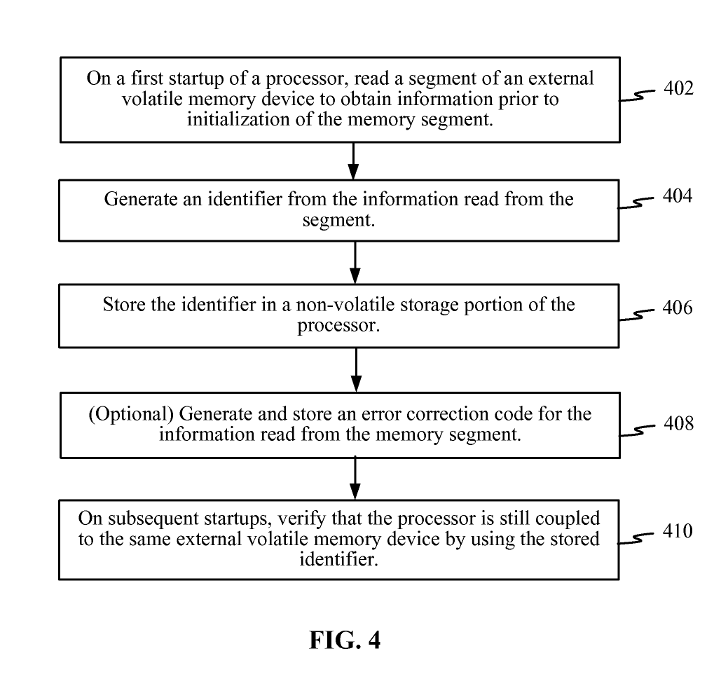

FIG. 4 illustrates a method operational by a processor to bind the processor to a volatile memory device by using an identifier obtained from the uninitialized volatile memory device. On a first startup of a processor, a segment of an external volatile memory device is read to obtain information prior to initialization of the memory segment 402. An identifier may then be generated from the information read from the segment 404. The identifier may be stored in a non-volatile storage portion of the processor 406. Optionally, the processor may generate and/or store an error correction code for the information read from the memory segment 408. In one example, the entirety of the information read is used to generate the identifier and the error correction code covers the entirety of the identifier and/or information read. In another example, a first portion of the information read is used to generate the identifier and a second portion of the information (e.g., overlapping or non-overlapping with the first portion) serves to generate the error correction code. On subsequent startups, the processor may verify that it is still coupled to the same external volatile memory device by using the stored identifier 410.

In some implementations, additional segments may be read from other external volatile memory devices to obtain additional information prior to initialization of the one or more other memory segments. In some examples, the identifier may be further generated from the additional information read from the one or more other memory segments. In other examples, different additional identifiers may be generated from the additional segments. Consequently, a plurality of distinct identifiers may be used to ascertain whether a processor is still coupled to its original circuit. For instance, identifier A, identifier B, and identifier C may be generated from the same and/or different segments on one or more external volatile memory devices, if there is a subsequent match of at least a subset of these identifiers (e.g., 1 out of 3, 2 out of 3, or 3 out of 3), then a successful verification/authentication may be concluded.

In one example, verifying that the processor is still coupled to the same external volatile memory device may include: (a) retrieving the previously stored identifier from the non-volatile storage of the processor; and/or (b) disabling operation of the processor if a subsequently obtained identifier for the same memory segment is not the same as the previously stored identifier.

In another example, the method may further comprise reading the memory segment of the external volatile memory device prior to initialization of the memory segment on a restart of the processor. A second identifier may be generated from the information read from the memory segment. The previously stored identifier may be retrieved from the non-volatile storage of the processor. Operation of the processor may be disabled (e.g., halted or placed in an endless loop to prevent further expected operations) if the generated second identifier is not the same as the previously stored identifier.

In yet another example, the processor may also generate and store an error correction code for the information read from the memory segment. The error correction code may be applied to a subsequently obtained second identifier during a restart of the processor prior to a comparison with the previously stored identifier.

In some implementations, the memory segment may comprise a plurality of n bytes obtained from memory cells of the external memory device prior to initializing the memory cells to some default value. The non-volatile storage of the processor includes burnable fuses.

According to one feature, generating the identifier from the information read from the memory segment may include: (a) reading the states of a plurality of memory cells within the memory segment, and (b) converting the plurality of states to the identifier. The states may include one of a logical 0 (low) or logical 1 (high). In one example, converting the plurality of states to the identifier includes at least one of: (a) concatenating the states of the plurality of memory cells as a binary sequence, and/or (b) performing a logic operation that combines at least some of the plurality of states of the plurality of memory cells into the identifier.

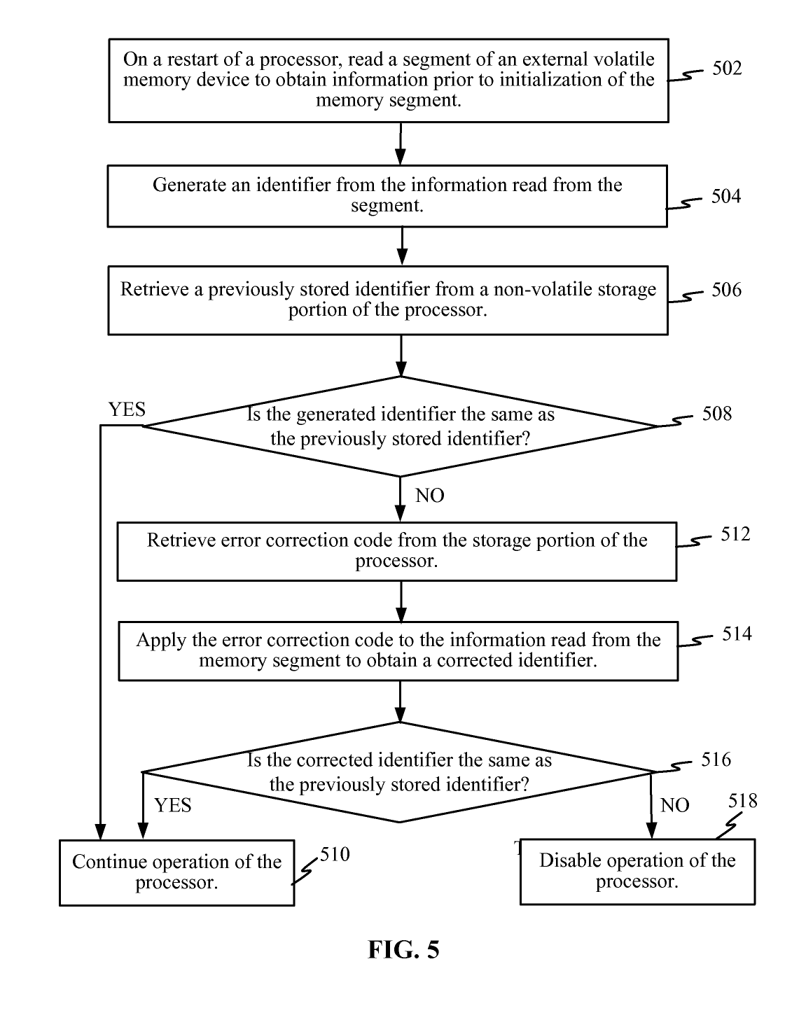

FIG. 5 is a flow diagram illustrating an example of how to verify a previous binding between a processor to a particular volatile memory device. On a restart of the processor, a segment of an external volatile memory device is read to obtain information prior to initialization of the memory segment 502. An identifier may be generated from the information read from the segment 504. A previously stored identifier may be retrieved from a non-volatile storage portion of the processor 506. The processor may then determine whether the generated identifier is the same as the previously stored identifier 508. If so, operation of the processor may continue 510.

According to one aspect, if an identifier match is not found in an initial comparison, an error correction code may be retrieved from the storage portion of the processor 512. The error correction code is then applied to the information read from the segment to obtain a corrected identifier 514. Again, the processor determines whether the corrected identifier is the same as the previously stored identifier 516. If there is a match, operation of the processor may continue 510. Otherwise, operation of the processor may be disabled or halted 518. Such disabling of the processor operation may include stopping executing of further instructions or executing of an endless loop which prevents other operations from being executed.

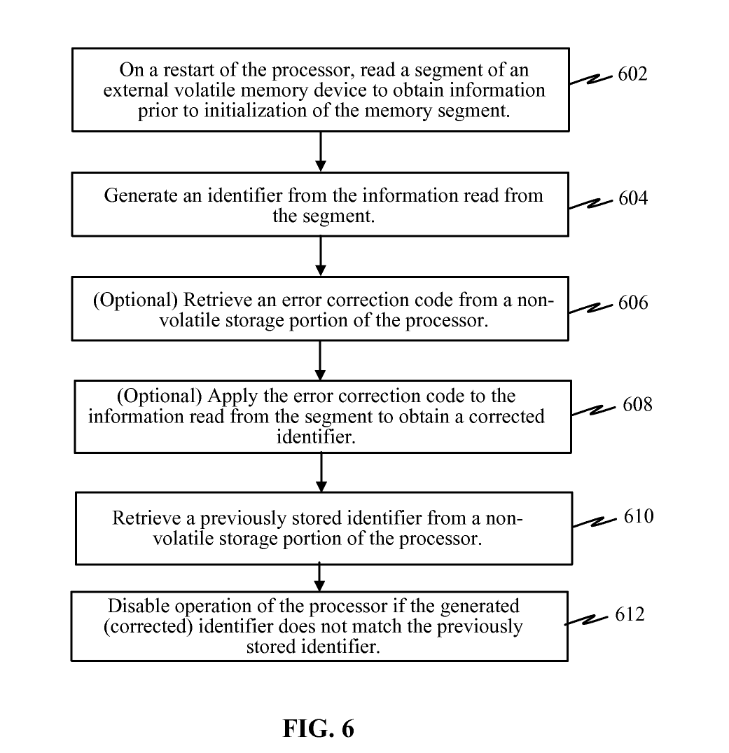

FIG. 6 illustrates a method for binding a processor to a particular external volatile memory device. On a restart of the processor, a segment of an external volatile memory device is read to obtain information prior to initialization of the memory segment 602. That is, the memory segment is read prior to the volatile memory device being set to a default state (e.g., all set to 0 or 1). An identifier may be generated from the information read from the segment 604. Optionally, an error correction code may be retrieved from the storage portion of the processor 606. The error correction code may be applied to the information read from the segment to obtain a corrected identifier 608. A previously stored identifier may be retrieved from a non-volatile storage portion of the processor 610. Operation of the processor may be disabled if the generated (corrected) identifier does not match the previously stored identifier 612. For instance, such match may be an exact match, a partial match above a threshold, a probabilistic match, or a closest match.

In several examples provided herein, it is assumed that while some uninitialized memory cells/junctions may be predictably biased to a particular state (e.g., binary or logical states 0 or 1) on every or most startups, other memory cells may be unpredictable on every startup. Consequently, error correcting code is applied over the whole memory segment used to generate an identifier. Such error correcting code may rely on a minimum percentage of memory cells/junctions having the same state as the initial boot-up, thereby allowing to a “corrected” identifier to be generated and compared to the a previously stored original identifier.

In an alternative approach, rather than relying on the fuzzy extractors for error correction or in addition to the use of fuzzy extractor, the processor may seek to identify the predictably biased memory cells/junctions from the unpredictable memory cells/junctions. For instance, the processor may perform multiple boot-ups (e.g., during a manufacturing test phase, the first n boot-ups of the processor, etc.) and record multiple versions of the identifier obtained from an uninitialized memory segment. These multiple versions of the identifier may then be used by the processor to generate a verification identifier in which only the states of the memory cells/junctions that were consistently the same in the multiple versions of the identifier are used to generate the verification identifier. In another example, the states of the memory cells/junctions that were the same in at least a minimum threshold (e.g., 50% or more, 60% or more, 70% or more, etc.) of the multiple versions of the identifier are used to generate the verification identifier.

In yet another alternative approach, the processor may permanently store a plurality of identifiers obtained from a segment of a volatile memory device on different boot-ups of the processor (e.g., the first n boot-ups). The plurality of identifiers may then be used to compare to subsequent identifiers obtained for verification in later boot-ups. If a comparison of a currently obtained identifier with a first previously stored identifier fails, a second previously stored identifier may be used for verification, and so forth until all previously stored identifiers are exhausted or the currently obtained identifier is successfully verified.

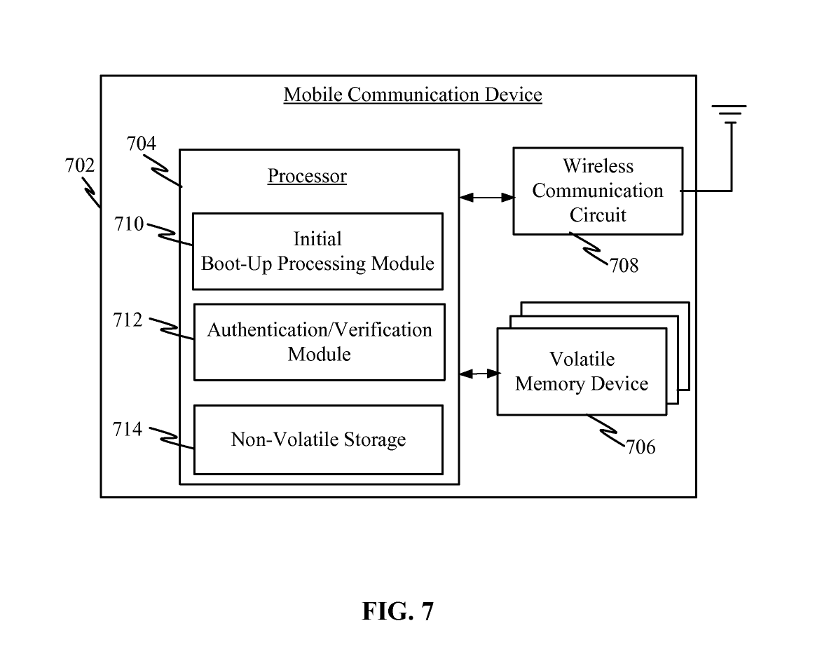

FIG. 7 is a block diagram illustrating an exemplary mobile communication device that includes a processor that is bound to one or more volatile memory devices. The mobile communication device may include a wireless communication circuit 708 (e.g., a transmitter/receiver for communicating over a network), a volatile memory device 706 (e.g., random access memory, etc.), and a processor 704 coupled to the wireless communication circuit 708 and/or the volatile memory device 706. On a first startup of the processor, an initial boot-up processing module/circuit 710 may cause the processor 704 (e.g., processing circuit, etc.) to read a memory segment of the volatile memory device 706 to obtain information prior to initialization of the memory segment. The initial boot-up processing module/circuit 710 of the processor 704 then (a) generates an identifier from the information read from the memory segment, and (b) stores the identifier in a non-volatile storage 714 of the processor. An authentication/verification module/circuit 712 may cause the processor 704 to verify that it is still coupled to the same external volatile memory device 706 by: (a) retrieving the previously stored identifier from the non-volatile storage of the processor; and/or (b) disabling operation of the processor if a subsequently obtained identifier for the same memory segment does not match the previously stored identifier. Matching the subsequently obtained identifier to the previously stored identifier may include one of an exact match or a partial match above a threshold.

According to one feature, the processor 704 may be further adapted to generate an error correcting code for the previously stored identifier and/or the information read. In one example, the error correcting code may include fuzzy extractors that permit correcting errors in the subsequently obtained identifier and/or subsequently obtained information from the same memory segment.

According to another feature, the processor may be further adapted to: (a) read the memory segment of the external volatile memory device to obtain a new information instance prior to initialization of the memory segment on a restart of the processor, (b) generate a second identifier from the new information instance read from the memory segment; (c) retrieve the previously stored identifier from the non-volatile storage of the processor; and/or (d) disable operation of the processor if the generated second identifier does not match the previously stored identifier.

It should be recognized that, generally, most of the processing described in this disclosure may be implemented in a similar fashion. Any of the circuit(s) or circuit sections may be implemented alone or in combination as part of an integrated circuit with one or more processors. The one or more of the circuits may be implemented on an integrated circuit, an Advance RISC Machine (ARM) processor, a digital signal processor (DSP), a general purpose processor, etc.

Also, it is noted that the embodiments may be described as a process that is depicted as a flowchart, a flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed. A process may correspond to a method, a function, a procedure, a subroutine, a subprogram, etc. When a process corresponds to a function, its termination corresponds to a return of the function to the calling function or the main function.

As used in this application, the terms “component,” “module,” “system,” and the like are intended to refer to a computer-related entity, either hardware, firmware, a combination of hardware and software, software, or software in execution. For example, a component may be, but is not limited to being, a process running on a processor, a processor, an object, an executable, a thread of execution, a program, and/or a computer. By way of illustration, both an application running on a computing device and the computing device can be a component. One or more components can reside within a process and/or thread of execution and a component may be localized on one computer and/or distributed between two or more computers. In addition, these components can execute from various computer readable media having various data structures stored thereon. The components may communicate by way of local and/or remote processes such as in accordance with a signal having one or more data packets (e.g., data from one component interacting with another component in a local system, distributed system, and/or across a network such as the Internet with other systems by way of the signal).

Moreover, a storage medium may represent one or more devices for storing data, including read-only memory (ROM), random access memory (RAM), magnetic disk storage mediums, optical storage mediums, flash memory devices and/or other machine readable mediums for storing information. The term “machine readable medium” includes, but is not limited to portable or fixed storage devices, optical storage devices, wireless channels and various other mediums capable of storing, containing or carrying instruction(s) and/or data.

Furthermore, embodiments may be implemented by hardware, software, firmware, middleware, microcode, or any combination thereof. When implemented in software, firmware, middleware or microcode, the program code or code segments to perform the necessary tasks may be stored in a machine-readable medium such as a storage medium or other storage(s). A processor may perform the necessary tasks. A code segment may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, etc.

One or more of the components, steps, and/or functions illustrated in Figures may be rearranged and/or combined into a single component, step, or function or embodied in several components, steps, or functions. Additional elements, components, steps, and/or functions may also be added. The apparatus, devices, and/or components illustrated in Figures may be configured to perform one or more of the methods, features, or steps described in other Figures. The algorithms described herein may be efficiently implemented in software and/or embedded hardware.

Those of skill in the art would further appreciate that the various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system.

The description of the embodiments is intended to be illustrative, and not to limit the scope of the claims. As such, the present teachings can be readily applied to other types of apparatuses and many alternatives, modifications, and variations will be apparent to those skilled in the art.

What is claimed is:

1. A method of binding a processor to a particular external volatile memory device, comprising:
on a first startup of the processor, reading a memory segment of the external volatile memory device to obtain information prior to initialization of the memory segment;
generating an identifier from the information read from the memory segment; and
storing the identifier in a non-volatile storage of the processor.

2. The method of claim 1, further comprising:
on subsequent startups, verifying that the processor is still coupled to the same external volatile memory device by using the stored identifier.

3. The method of claim 2, wherein verifying that the processor is still coupled to the same external volatile memory device includes:
retrieving the previously stored identifier from the non-volatile storage of the processor; and
disabling operation of the processor if a subsequently obtained identifier for the same memory segment does not match the previously stored identifier.

4. The method of claim 1, further comprising:
on a restart of the processor, reading the memory segment of the external volatile memory device prior to initialization of the memory segment;
generating a second identifier from information read from the memory segment;
retrieving the previously stored identifier from the non-volatile storage of the processor; and
disabling operation of the processor if the generated second identifier does not match the previously stored identifier.

5. The method of claim 1, further comprising:
generating and storing an error correction code for the information read from the memory segment; and
applying the error correction code to a subsequently obtained second identifier during a restart of the processor prior to a comparison with the previously stored identifier.

6. The method of claim 1, wherein the memory segment comprises a plurality of n bytes obtained from memory cells of the external memory device prior to initializing the memory cells to any value.

7. The method of claim 1, wherein the non-volatile storage of the processor includes a one-time writable storage.

8. The method of claim 1, wherein generating the identifier from the information read from the memory segment includes:
reading states of a plurality of memory cells within the memory segment, and
converting the plurality of states to the identifier.

9. The method of claim 8, wherein the states include one of a logical 0 and a logical 1.

10. The method of claim 8, wherein converting the plurality of states to the identifier includes at least one of:
concatenating the states of the plurality of memory cells as a binary sequence, and/or
performing a logic operation that combines at least some of the plurality of states of the plurality of memory cells into the identifier.

11. The method of claim 1, further comprising:
reading one or more other memory segments of different external volatile memory devices to obtain additional information prior to initialization of the one or more other memory segments,
wherein the identifier is further generated from the additional information read from the one or more other memory segments.

12. The method of claim 1, further comprising:
reading one or more other memory segments of different external volatile memory devices to obtain additional information prior to initialization of the one or more other memory segments;
generating a plurality of identifiers from the additional information read from the one or more other memory segments; and
storing the plurality of identifiers in the non-volatile storage of the processor.

13. The method of claim 1, wherein the identifier is generated from a first portion of the information read, and further comprising:
generating one or more additional identifiers from other portions of the information read; and
storing the one or more additional identifiers in the non-volatile storage of the processor.

14. A processor, comprising:
a non-volatile storage; and
a processing circuit coupled to the non-volatile storage and configured to:
on a first startup of the processor, read a memory segment of an external volatile memory device to obtain information prior to initialization of the memory segment,
generate an identifier from the information read from the memory segment, and store the identifier in the non-volatile storage.

15. The processor of claim 14, wherein the processing circuit is further adapted to:
on subsequent startups, verify that the processor is still coupled to the same external volatile memory device by using the stored identifier.

16. The processor of claim 15, wherein verifying that the processor is still coupled to the same external volatile memory device includes:
retrieving the previously stored identifier from the non-volatile storage of the processor; and
disabling operation of the processor if a subsequently obtained identifier for the same memory segment does not match the previously stored identifier.

17. The processor of claim 14, wherein the processing circuit is further adapted to:
on a restart of the processor, read the memory segment of the external volatile memory device to obtain information prior to initialization of the memory segment;
generate a second identifier from the information read from the memory segment;
retrieve the previously stored identifier from the non-volatile storage of the processor; and
disable operation of the processor if the generated second identifier does not match the previously stored identifier.

18. A processor, comprising:
means for reading a memory segment of an external volatile memory device to obtain information prior to initialization of the memory segment on a first startup of the processor;
means for generating an identifier from the information read from the memory segment; and
means for storing the identifier in a non-volatile storage of the processor.

19. The processor of claim 18, further comprising:
means for verifying that the processor is still coupled to the same external volatile memory device by using the stored identifier on subsequent startups.

20. A processor-readable storage medium comprising instructions which when executed by a processor causes the processor to:
read a memory segment of the external volatile memory device to obtain information prior to initialization of the memory segment on a first startup of the processor;
generate an identifier from information read from the memory segment; and
store the identifier in a non-volatile storage of the processor.

21. The processor-readable storage medium of claim 20, including further instructions which when executed by the processor causes the processor to:
verify that the processor is still coupled to the same external volatile memory device by using the stored identifier on subsequent startups.

22. A method for binding a processor to a particular external volatile memory device, comprising:
on a restart of the processor, reading a segment of an external volatile memory device to obtain information prior to initialization of the memory segment;
generating an identifier from the information read from the memory segment;
retrieving a previously stored identifier from a non-volatile storage of the processor; and
disabling operation of the processor if the generated identifier does not match the previously stored identifier.

23. The method of claim 22, further comprising:
retrieving an error correction code from the non-volatile storage of the processor;
applying the error correction code to the information read from the memory segment to obtain a corrected identifier;
disabling operation of the processor if the corrected identifier does not match the previously stored identifier.

24. A processor, comprising:
a non-volatile storage; and
a processing circuit coupled to the non-volatile storage and configured to:
read a segment of an external volatile memory device to obtain information prior to initialization of the memory segment on a restart of the processor,
generate an identifier from the information read from the memory segment,
retrieve a previously stored identifier from the non-volatile storage of the processor, and
disable operation of the processor if the generated identifier does not match the previously stored identifier.

25. A processor, comprising:
means for reading a segment of an external volatile memory device to obtain information prior to initialization of the memory segment on a restart of the processor;
means for generating an identifier from the information read from the memory segment;
means for retrieving a previously stored identifier from a non-volatile storage of the processor; and
means for disabling operation of the processor if the generated identifier does not match the previously stored identifier.

26. A processor-readable storage medium comprising instructions which when executed by a processor causes the processor to:
read a segment of an external volatile memory device to obtain information prior to initialization of the memory segment on a restart of the processor;
generate an identifier from information read from the memory segment;
retrieve a previously stored identifier from a non-volatile storage of the processor; and
disable operation of the processor if the generated identifier does not match the previously stored identifier.

27. A mobile communication device, comprising:
a wireless communication circuit;
a volatile memory device; and
a processor coupled to the wireless communication circuit and the memory device, the processor adapted to:
on a first startup of the processor, read a memory segment of the volatile memory device to obtain information prior to initialization of the memory segment,
generate an identifier from the information read from the memory segment, and
store the identifier in a non-volatile storage of the processor.

28. The mobile communication device of claim 27, wherein verifying that the processor is still coupled to the same external volatile memory device includes:
retrieving the previously stored identifier from the non-volatile storage of the processor; and
disabling operation of the processor if a subsequently obtained identifier for the same memory segment does not match the previously stored identifier.

29. The mobile communication device of claim 28, wherein matching the subsequently obtained identifier to the previously stored identifier includes one of an exact match or a partial match above a threshold.

30. The mobile communication device of claim 27, wherein the processor is further adapted to:
generate an error correcting code for the previously stored identifier and/or the information read.

31. The mobile communication device of claim 30, wherein the error correcting code includes fuzzy extractors that permit correcting errors in the subsequently obtained identifier and/or subsequently obtained information from the same memory segment.

32. The mobile communication device of claim 27, wherein the processor is further adapted to:
on a restart of the processor, read the memory segment of the external volatile memory device to obtain a new information instance prior to initialization of the memory segment;
generate a second identifier from the new information instance read from the memory segment;
retrieve the previously stored identifier from the non-volatile storage of the processor; and
disable operation of the processor if the generated second identifier does not match the previously stored identifier.

33. A mobile communication device, comprising:
means for reading a memory segment of a volatile memory device to obtain information prior to initialization of the memory segment on a first startup of a processor;
means for generating an identifier from the information read from the memory segment; and
means for storing the identifier in a non-volatile storage of the processor.

34. The mobile communication device of claim 33, further comprising:
means for reading the memory segment of the external volatile memory device to obtain a new information instance prior to initialization of the memory segment on a restart of a processor;
means for generating a second identifier from the new information instance read from the memory segment;
means for retrieving the previously stored identifier from the non-volatile storage of the processor; and
means for disabling operation of the processor if the generated second identifier does not match the previously stored identifier.
